(19) United States
(12) Patent Application Publication
(10) Pub. No.: US 2024/0289800 A1
(43) Pub. Date: Aug. 29, 2024

(54) Self-Checkout System

(71) Applicant: Toshiba Global Commerce Solutions, Inc., Durham, NC (US)

(72) Inventor: Kevin Hunter Vorhees, Raleigh, NC (US)

(21) Appl. No.: 18/113,186

(22) Filed: Feb. 23, 2023

(51) Int. Cl. G06Q 20/40; G06Q 20/20

(52) U.S. Cl. CPC G06Q 20/4016; G06Q 20/208

(57) ABSTRACT

A computing device determines that a duplicate scan has occurred. To do so, the computing device receives, during a sales transaction, a first image of an item comprising a first barcode and a second image comprising a second barcode. The computing device interrupts the sales transaction responsive to the first barcode and the second barcode being the same and a first feature in the first image associated with the first barcode matching a second feature in the second image associated with the second barcode.

### BACKGROUND

Retail self-checkout systems are intended to give customers an easier alternative to traditional full-service or employee-lead checkout processes. Self-checkout systems often rely heavily on software programs stored on a computing device and input devices to account for purchase items. Most systems include hand-held or stationary scanning input devices to detect a barcode or QR code on the item. In these systems, customers systematically scan each item until they are ready to tender payment. The scanners produce images of the barcode. The barcode images are decoded, and the items are identified and recorded by the computing device. Recordation may include adding identified items in an ongoing sales transaction and printing a receipt. In the absence of employee assistance, the integrity of self-checkout may be compromised. Errors such as incorrectly recording items in duplicate, or not recording them at all, may occur during checkout. Problems arising from these errors such as retail theft or overpayment, affect both the retailer and the customer.

### BRIEF DESCRIPTION OF THE DRAWINGS

Aspects of the present disclosure are illustrated by way of example and are not limited by the accompanying Figures with like references indicating like elements.

FIG. 1 is a schematic block diagram that illustrates an exemplary image according to one or more embodiments of the present disclosure.

FIGS. 2A-F are schematics of images including items with incidental features.

FIG. 3 is a flow diagram illustrating a method implemented by a computing device.

FIG. 4 is a flow diagram illustrating a method implemented by a computing device.

FIG. 5 is a schematic block diagram illustrating an exemplary computing device according to one or more embodiments of the present disclosure.

### DETAILED DESCRIPTION

The present disclosure provides methods for evaluating images of an item to identify whether the same instance of an item has been scanned and recorded by a computing device more than once.

During a sales transaction, a self-service system, including a computing device is configured to detect an image sensed by a scanner. As the items are systematically scanned, before adding the new item to the sales transaction, the computing device determines whether a scanned image is a new instance of the same item or the same instance of the item. For example, the computing device may determine whether two scans were made of two different boxes of the same cereal or whether the different scan images correspond to the same cereal box, in which each scan includes the same barcode.

If the computing device determines that the same instance of the item has been previously recorded, the computing device blocks the completion of the transaction until the identified duplicate scan is resolved.

Physical items located in retail stores tend to have minor differences in the barcode area of the product and/or packaging. These differences can be used to determine that the same instance of an item was scanned more than once.

The embodiments disclosed herein may protect the retailer from theft due to inaccurate sales receipts, and protect the consumer from overpaying for items unintentionally recorded. For example, a shopper might accidentally or intentionally scan a lower-priced item two times, and not scan a higher-priced item, so the total item count at the store exit is still accurate but with a lower price total, thereby resulting in a potential loss for the store. In another example, the scanner may also automatically continuously scan, resulting in a duplicate reading of an item being scanned. In general, security checks performed by an employee at a store exit may be compromised when the items or item count on a printed receipt does not match the items in the cart.

In view of the above, embodiments of the present disclosure provide a method of checking whether a notable feature in one image of an item also appears in a corresponding place in a second image including the same barcode. If the self-checkout system is enabled to recognize incidental features in the barcode area of the product, the store can detect if the same item was scanned more than once, and notify the shopper during the scanning process so it can be corrected.

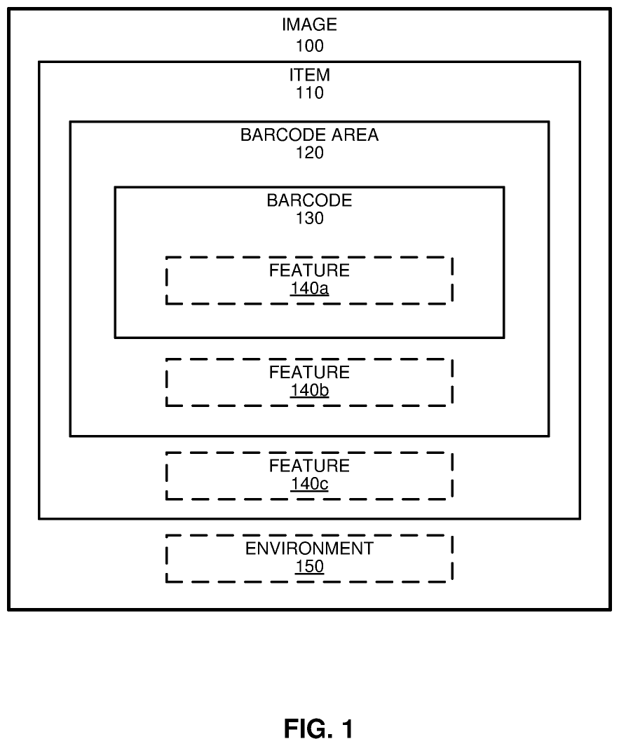

FIG. 1 is a block diagram illustrating an exemplary schematic diagram of an image 100 of an item 110. The item 110 includes a barcode area 120, which in turn includes a barcode 130.

Item 110 may be fully or partially represented in the image depending on the size of item 110 and the sensory range of the image scanner. The barcode 130 may also be a QR code or any other decodable identifier.

Environment 150 may be included in the image. For example, the item 110 may only represent a part of the entire image 100 such that something behind the item 110 can be seen.

As illustrated in FIG. 1, incidental features 140a-c may additionally or alternatively appear in one or more areas of image 100. For example, feature 140a is included on barcode 130, and feature 140b is outside of the barcode 130 but inside the barcode area 120. Feature 140c is on item 110 outside of the barcode area 120.

Each image 100 is generally (but not necessarily) expected to include at least incidental features 140a-c somewhere on the item 110. Incidental features 140a-c are unique to a particular instance of the item 110. For example, they may be caused during manufacturing, packaging, shipping, and stocking. Additionally or alternatively, they may range from a significant product defect or general wear and tear.

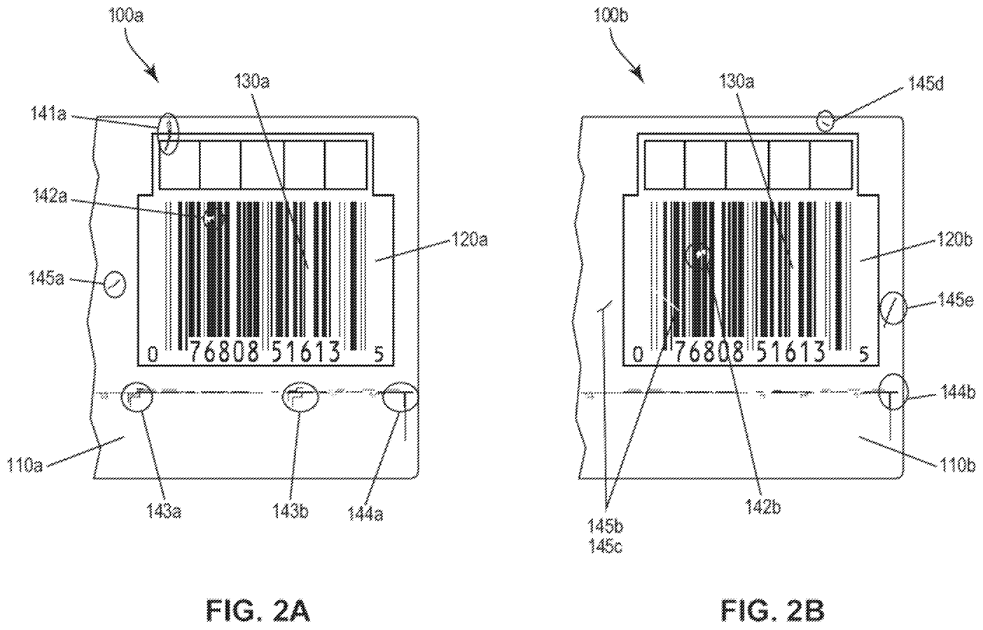

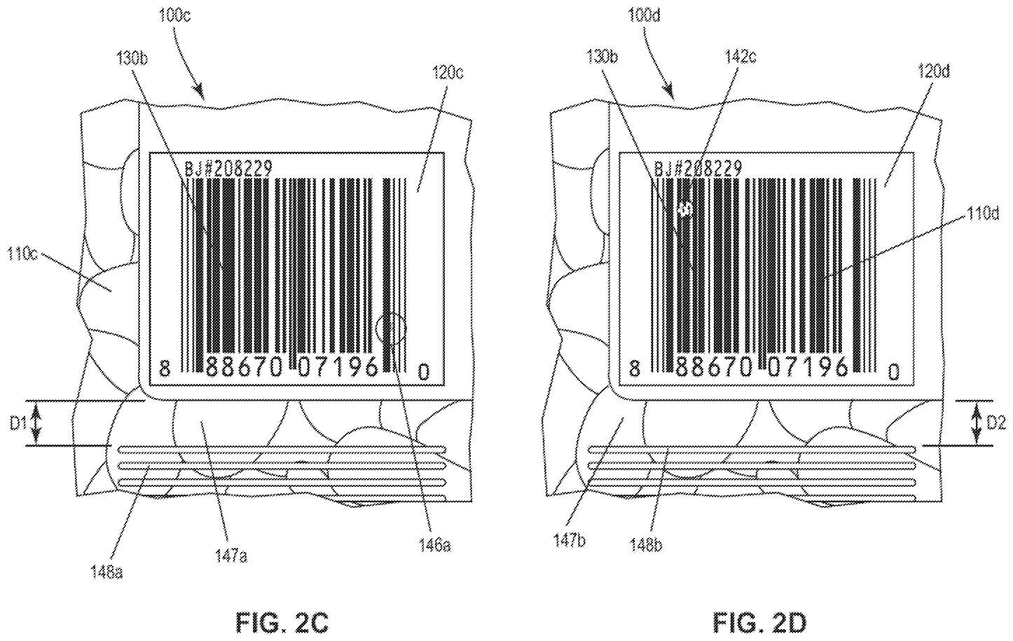

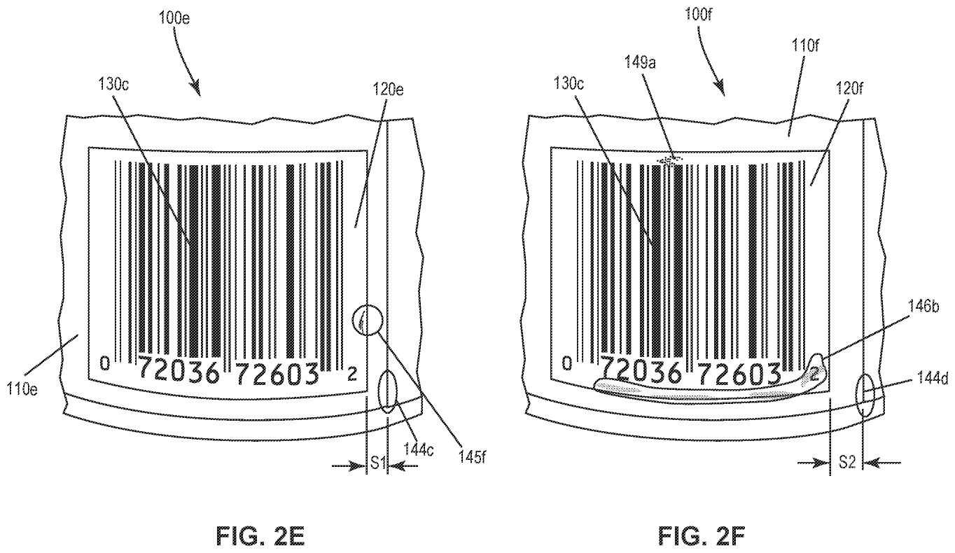

FIGS. 2A-F illustrate images 100 of the barcode area 120 from three different products, with two instances of each item 110. Each image 100 includes noticeable differences. For example, differences due to stray printing, smudges, dust stuck on the packaging, scratches, missing ink, a varying distance from the barcode to a seam, different seam overlappings, dents in the packaging, and for transparent packaging with different items inside the container. Additional features include the distance from the label to an incidental feature, for example, a ridge, product color, shape, and pattern.

FIGS. 2A-B are examples of images 100a-b. FIG. 2A includes different instances of the same item 110a-b (e.g., cereal). Each of the items 110a-b includes barcode 130a in its respective barcode area 120a-b. Each of the items 110a-b has its own incidental features 140a-c.

In FIG. 2A, the item 110a includes incidental features 140 including a stray printing 141a, a scratch 145a, missing ink 142a, dents 143a-b and a seam overlap 144a. In FIG. 2B, item 110b includes incidental features 140, including missing ink 142b, scratches 145b-e, and a seam overlap 144b. The barcode 130a is the same in both images 110a-b. However, incidental features 140 appear in different areas of each image. Thus, in this example, the customer has two separate instances of the same item 110a. Accordingly, the computing device determines that the customer has two separate instances of the same item 110a-b based on at least one of the incidental features 140 in one of the images 110a-b being unmatched to corresponding locations in the other of the images 110a-b.

FIGS. 2C-D are further examples of images 100c-d including different instances of the same item 110c-d. Both FIGS. 2C-D include a barcode 130b, barcode areas 120c-d, and incidental features 140a-c.

FIG. 2C includes incidental features including a smudge 146a, item color, pattern and shape 147a, a ridge 148a and the distance D1 from ridge 148a to barcode area 120c. FIG. 2D includes incidental features including missing ink 142c, item color, pattern and shape 147b, a ridge 148b and a distance D2 from ridge 148b to barcode area 120d. In this example, the customer has two separate instances of the same item. The computing device will determine this based on at least one of the unmatched incidental features, the unmatched locations of the features, and the difference in distance D1 compared to distance D2.

In some examples, the item may be packaged in transparent packaging. The incidental features 147a-b may be identified according to the pattern, shape, and color of the product inside the transparent packaging. As an example, the nuts in a transparent plastic jar will appear to form different patterns as compared to a printed label as illustrated in FIGS. 2C-D.

FIGS. 2E-F are further examples of images 100e-f including different instances of the same item 110e-f. Both FIGS. 2E-F include a barcode 130c, barcode areas 120e-f, and incidental features 140a-c.

FIG. 2E includes incidental features including a scratch 145f, a seam 144c, and the distance S1 from seam 144c to barcode area 120e. FIG. 2F includes incidental features including smudge 146b, a seam 144d, dust 149a and a distance S2 from seam 144d to barcode area 120f. In this example, the customer has two separate instances of the same item. The computing device will determine this based on at least one of the unmatched incidental features, the unmatched locations of the features, and the difference in distance S1 compared to distance S2.

According to embodiments of the present disclosure, images 100 determined to include the same barcode 130 are compared to determine whether or not the same instance of an item is scanned twice based on the incidental features 140a-c detected on the item 110.

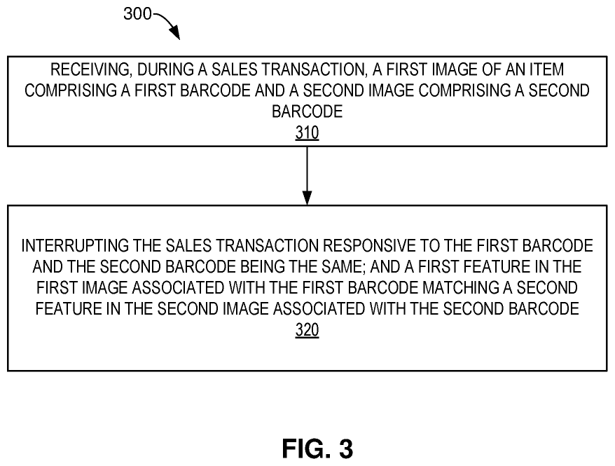

FIG. 3 is a flow chart illustrating method 300, consistent with the discussion above. According to one or more embodiments of the present disclosure, method 300 performed by a computing device includes receiving, during a sales transaction, a first image 100a of an item 110a including a first barcode 130a and a second image 110b including a second barcode 130a (block 310). Method 300 further includes interrupting the sales transaction responsive to the first barcode and the second barcode being the same and a first feature in the first image associated with the first barcode matching a second feature in the second image associated with the second barcode (block 320).

According to some embodiments, the first feature and the second feature is a stray printing 141a on the item in the first image also appears in the second image.

According to some embodiments, the first feature and the second feature is a smudge 146a-b on the item in the first image also appears in the second image.

According to some embodiments, the first feature and the second feature is dust 149 on the item in the first image also appears in the second image.

According to some embodiments, the first feature and the second feature is a scratch 145a-f on the item in the first image also appears in the second image.

According to some embodiments, the first feature and the second feature is an area of missing ink 142a-c on the item in the first image also appears in the second image.

According to some embodiments, wherein the first feature and the second feature are at a same distance (S1, S2) from an edge or seam 144a on the item in the first image and the second image.

According to some embodiments, the first features and the second feature is a dent 143a-b on the item in the first image also appears in the second image.

According to some embodiments, wherein the first feature and the second feature are overlapping packaging seams 144a-b on the item in the first image also appear in the second image.

According to some embodiments, wherein the first feature and the second feature are contents comprised within a transparent packaging of the item in the first image also appearing in the second image.

According to some embodiments, interrupting the sales transaction is responsive to determining that a distance D1 from an incidental feature 140a-d to a barcode area on the item in the first image is the same as a distance D2 from an incidental feature 140a-d to a barcode area on the item in the second image.

According to some embodiments, interrupting the sales transaction is responsive to determining that one or more features appearing on an item in the first image also appear in the second image.

During the manufacture or shipping of items, common defects may appear on a certain lot or batch of items. The defects could be, for example, environmental (.i.e., dust) or caused by a printing malfunction in an assembly line (i.e., a stray printing or missing ink).

According to some embodiments, interrupting the sales transaction is further based on whether more than a threshold number of features in the first image also appears in the second image.

According to some embodiments, the method further includes determining, for each of a plurality of features appearing in both the first item and the second item, a feature type and calculating a similarity score based on a weight corresponding to the feature type of each feature and interrupting the sales transaction responsive to determining that the similarity score exceeds a threshold.

According to some embodiments, the method further includes determining, for each of a plurality of features appearing in both the first item and the second item, based on collecting and/or stored historical data.

According to some embodiments, of interrupting the sales transaction includes prompting the user to rescan another item or indicate that the item should be added to the sales transaction and additional time.

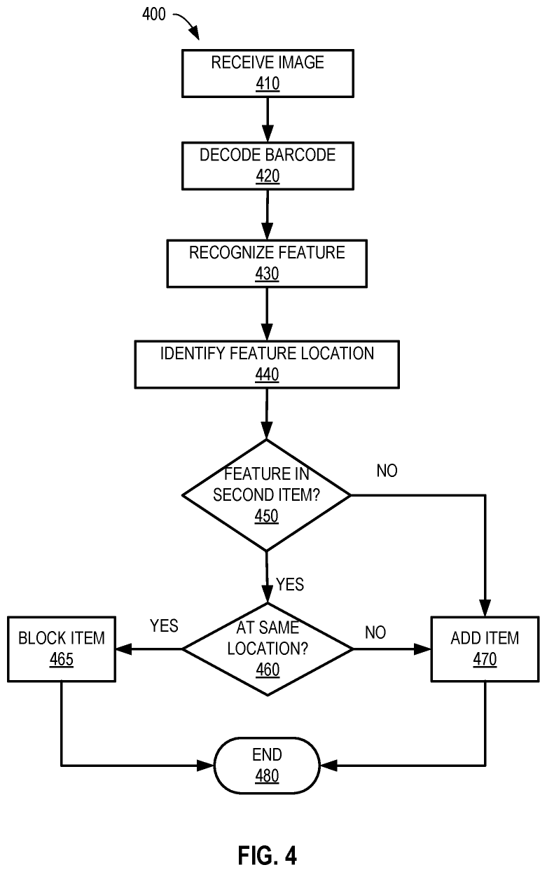

FIG. 4 is a flow chart illustrating another method for detecting a duplicate scan according to one or more embodiments of the present disclosure. Method 400, performed by a computing device, includes receiving an item image (410) and decoding the barcode 130 included in the image (420). The method 400 further includes recognizing a feature on an area of the first item (430) and a first location of the feature relative to the first barcode on the first item (440). The method further includes determining whether or not the feature appears on a second location relative to the second barcode on a second item, the second location corresponding to the same first location (450). If so, the method further includes determining whether or not the same incidental feature is located at the same position on the second item (460). If it is determined that the same incidental feature is not located in the same location, the item information associated with the item is added to the sale transaction (470). Alternatively, if it is determined that the same incidental feature is located in the same location, the computing device blocks the item (465) from being added to the transaction, and the process ends (480).

According to some embodiments in which the same feature is identified at corresponding locations in both images, the user may be notified that the same item was scanned twice. In such embodiments, the user may then be prompted to scan a new item or allow the item to be added to the transaction. If the user scans another item, the first image is deleted, and the process repeats at 410.

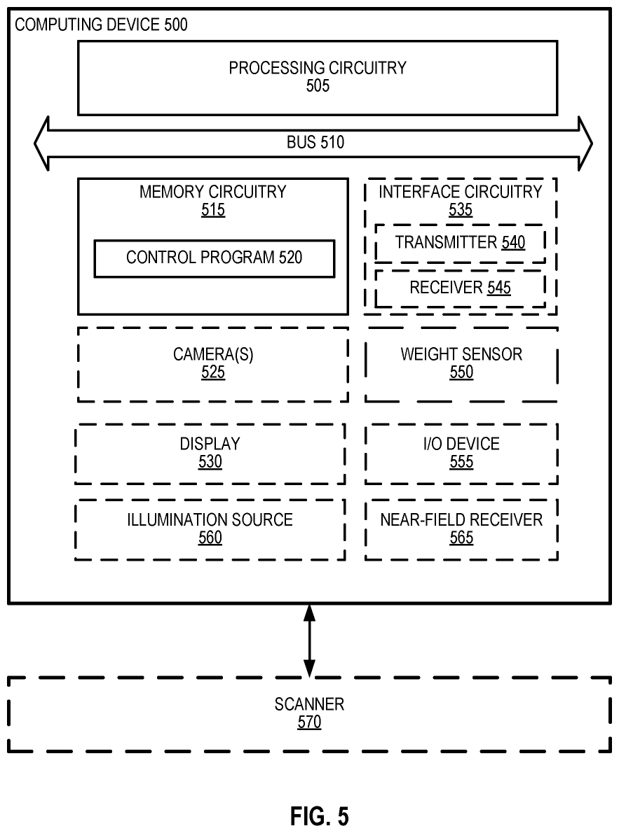

FIG. 5 is a schematic block diagram that illustrates an exemplary computing device 500 according to one or more embodiments of the present disclosure. The example computing device includes processing circuitry 505, memory circuitry 515, and interface circuitry 535. The processing circuitry 505 is communicatively coupled to the memory circuitry 515 and the interface circuitry 535, e.g., via one or more buses 510. The processing circuitry 505 may include one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 505 may be programmable hardware capable of executing software instructions 520 stored, e.g., as a machine-readable computer program in the memory circuitry 515. The memory circuitry 515 of the various embodiments may include any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 535 may be a controller hub configured to control the input and output (I/O) data paths of the computing device 500. Such I/O data paths may include data paths for exchanging signals over a communications network and data paths for exchanging signals with a user. For example, the interface circuitry 535 may include a transceiver configured to send and receive communication signals over one or more of a cellular network, Ethernet network, or optical network. The interface circuitry 535 may also include (or be communicatively connected to) one or more of a graphics adapter, display port, video bus, touchscreen, graphical processing unit (GPU), display port, Liquid Crystal Display (LCD), and Light Emitting Diode (LED) display, for presenting visual information to a user. The interface circuitry 535 may also include one or more of a pointing device (e.g., a mouse, stylus, touchpad, trackball, pointing stick, joystick), touchscreen, microphone for speech input, optical sensor for optical recognition of gestures, and keyboard for text entry. In some embodiments, the computing device 500 may additionally or alternatively include one or more cameras 525, weight sensors 550, displays 530, I/O devices 555, illumination sources 560, and/or near-field receivers 565 as discussed above, either as part of the interface circuitry 535 or communicatively connected thereto.

The near-field receiver 565 may include a multi-dimensional image scanner configured to read decodable identifiers, for example, barcodes and QR codes.

The interface circuitry 535 may be implemented as a unitary physical component, or as a plurality of physical components that are contiguously or separately arranged, any of which may be communicatively coupled to any other, or may communicate with any other via the processing circuitry 505. For example, the interface circuitry 535 may include output circuitry 540 (e.g., transmitter circuitry configured to send communication signals over the communications network) and input circuitry 545 (e.g., receiver circuitry configured to receive communication signals over the communications network). Similarly, the output circuitry 540 may include a display 530, whereas the input circuitry 555 may include a keyboard, touch screen, or card reader. Other examples, permutations, and arrangements of the above and their equivalents will be readily apparent to those of ordinary skill.

The computing device 500 may be configured to perform the method 300 described above. For example, the processing circuitry 505 may be configured to receive, during a sales transaction, a first image 100a of an item 110a including a first barcode 130a and a second image 110b including a second barcode 130a. The processing circuitry 505 may be further configured to interrupt the sales transaction responsive to the first barcode and the second barcode being the same and a first feature in the first image associated with the first barcode matching a second feature in the second image associated with the second barcode.

Other embodiments include a non-transitory computer-readable medium (e.g., the memory circuitry 515) storing a computer program (e.g., control program 520) that includes software instructions that, when run on processing circuitry 505 of the computing device 500, causes the computing device 500 to perform any of the methods disclosed herein.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein. Although steps of various processes or methods described herein may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention.

1. A method performed by a computing device, comprising:
receiving, during a sales transaction, a first image of an item comprising a first barcode and a second image comprising a second barcode; and
interrupting the sales transaction responsive to:
the first barcode and the second barcode being the same; and
a first feature in the first image associated with the first barcode matching a second feature in the second image associated with the second barcode.

2. The method of claim 1, wherein the first feature and the second feature are a stray printing and/or an area of missing ink on the item.

3. The method of claim 1, wherein the first feature and the second feature are a smudge and/or dust on the item.

4. The method of claim 1, wherein the first feature and the second feature are a scratch and/or a dent on the item.

5. The method of claim 1, wherein the first feature and the second feature are at a same distance from an edge or seam on the item in the first image and the second image.

6. The method of claim 1, wherein the first feature and the second feature are overlapping packaging seams on the item in the first image also appear in the second image.

7. The method of claim 1, wherein the first feature and the second feature are contents comprised within a transparent packaging of the item in the first image also appearing in the second image.

8. The method of claim 1, wherein interrupting the sales transaction is further responsive to more than a threshold number of features in the first image also appearing in the second image.

9. The method of claim 1, further comprising:
determining, for each of a plurality of features appearing in both the first item and the second item, a feature type; and
calculating a similarity score based on a weight corresponding to the feature type of each feature;
wherein interrupting the sales transaction is further responsive to the similarity score exceeding a threshold.

10. A computing device, comprising:
processing circuitry and memory comprising instructions executable by the processing circuitry whereby the computing device is configured to:
receive, during a sales transaction, a first image of an item comprising a first barcode and a second image comprising a second barcode; and
interrupt the sales transaction responsive to:
the first barcode and the second barcode being the same; and
a first feature in the first image associated with the first barcode matching a second feature in the second image associated with the second barcode.

11. The computing device of claim 11, wherein the first feature and the second feature are a stray printing and/or an area of missing ink on the item in the first image also appears in the second image.

12. The computing device of claim 11, wherein the first feature and the second feature are a smudge and/or dust on the item in the first image also appears in the second image.

13. The computing device of claim 11, wherein the first feature and the second feature are a scratch and/or a dent on the item in the first image also appears in the second image.

14. The computing device of claim 11, wherein the first barcode is at a same distance from an edge or seam on the item in the first image also appears in the second image.

15. The computing device of claim 11, wherein the first feature and the second feature are overlapping packaging seams on the item in the first image also appearing in the second image.

16. The computing device of claim 11, wherein the first feature and the second feature are contents comprised within a transparent packaging of the item in the first image also appear in the second image.

17. The computing device of claim 11, wherein the interrupting the sales transaction is further responsive to more than a threshold number of features in the first image also appearing in the second image.

18. The computing device of claim 11, wherein the computing device is further configured to:
determine, for each of a plurality of features appearing in both the first item and the second item, a feature type; and
calculate a similarity score based on a weight corresponding to the feature type of each feature;
wherein interrupting the sales transaction is further responsive to the similarity score exceeding a threshold.

19. A non-transitory computer readable medium storing a computer program, the computer program product comprising software instructions that, when run on a computing device, cause the computing device to:
receive, during a sales transaction, a first image of an item comprising a first barcode and a second image comprising a second barcode; and
interrupt the sales transaction responsive to:
the first barcode and the second barcode being the same; and
a first feature in the first image associated with the first barcode matching a second feature in the second image associated with the second barcode.

20. The non-transitory computer readable medium 19, wherein the software instructions that, when run on the computing device, further cause the computing device to:
determine, for each of a plurality of features appearing in both the first item and the second item, a feature type; and
calculate a similarity score based on a weight corresponding to the feature type of each feature;
wherein interrupting the sales transaction is further responsive to the similarity score exceeding a threshold.
